(19) United States
(12) Patent Application Publication
(10) Pub. No.: US 2018/0305596 A1
(43) Pub. Date: Oct. 25, 2018

(54) BINDER SYSTEMS COMPRISING EPOXIDE COMPOUNDS AND PREPOLYMERS BEARING ALKOXYSILYL GROUPS, AND USE THEREOF

(71) Applicant: Evonik Degussa GmbH, Essen (DE)

(72) Inventors: Frank SCHUBERT, Neukirchen-Vluyn (DE); Wilfried KNOTT, Essen (DE); Frank GRIMMELT, Essen (DE); Anke LEWIN, Duesseldorf (DE)

(73) Assignee: Evonik Degussa GmbH, Essen (DE)

(21) Appl. No.: 15/767,894

(22) PCT Filed: Oct. 28, 2016
(86) PCT No.: PCT/EP2016/076031

§ 371 Date: Apr. 12, 2018

(30) Foreign Application Priority Data
Nov. 26, 2015 (EP) 15196420.2

(51) Int. Cl. C09J 171/02; C08L 71/02; C08L 63/00; C08K 5/5419; C08K 5/29

(52) U.S. Cl. CPC C09J 171/02; C08L 71/02; C08G 18/283; C08K 5/5419; C08K 5/29; C08L 63/00

(57) ABSTRACT

The invention relates to curable mixtures comprising at least one binder composition and also at least one curing agent mixture and optionally one or more alkoxysilane compounds, and also to their use.

The invention relates to curable mixtures comprising at least one binder composition and also at least one curing agent mixture and optionally one or more alkoxysilane compounds, and also to their use.

Polymers, such as polyethers, polysiloxanes or polyurethanes, which carry alkoxysilyl groups have been known for a long time and are used as binders in moisture-curing adhesive/sealant formulations. In the cured state, the adhesives/sealants are notable for their high extensibility and elasticity, but they often lack mechanical strength and effective adhesion properties on critical substrates such as plastics. Particularly when applied in relatively thick layers and under conditions of low atmospheric humidity, curing through the volume of material is slow, and the surfaces frequently lack sufficient freedom from tack. This is so especially for the widespread silyl-terminated polymers, owing to their low density of reactive alkoxysilyl group functionality.

Cured epoxy resins, in contrast, are known for example for the very high strength, the good chemical resistance and temperature stability, and the high bond strength on numerous substrates. Epoxy resins cure with amines even in the absence of atmospheric humidity and even at below room temperature. Disadvantages for certain applications are the low extensibility and heightened brittleness of the cured epoxy resins. The pronounced exothermic heat change which accompanies curing usually—except for in highly filled systems—rules out application in relatively thick layers.

In practice it proves difficult to achieve a balanced properties profile of high extensibility and elasticity in conjunction with effective adhesion, rapid through-curing, high mechanical strength and chemical resistance. According to the prior art, therefore, there has been no lack of attempts to develop binders which unite these positive properties.

EP 0186191 B1 discloses curable mixtures comprising an alkoxysilyl-functional polymer, an epoxy resin, an aminosiloxane or aminosilane, and a curing agent for the epoxy resin. A disadvantage is that the four components can be mixed only immediately prior to application, in order to prevent the premature curing reaction of the epoxy resin. The selection of the alkoxysilyl-functional polymers that can be used is limited to, for example, polyethers, polyesters, polyacrylates, polyolefins and polysulphides. The group of the silyl-modified polyurethanes is not included. EP 0186191 B1 additionally observes that alkoxysilyl-functional polymers having pendent silyl groups are unsuitable, since they lead to embrittlement in the curable mixtures described.

EP 0370463 describes two-component systems in which component A is a mixture of alkoxysilyl-functional polymer and epoxy hardener, component B is a mixture of epoxy resin and an Sn-containing catalyst, and the two components A and B are combined at application. Again, the alkoxysilyl-functional polymers which can be used are limited to, for example, polyethers, polyesters, polyacrylates, polyolefins and polysulphides, and do not include silyl-modified polyurethanes.

EP 0671437 claims one-component systems comprising an alkoxysilyl-functional polymer, a curing catalyst for the alkoxysilyl-functional polymer, an epoxy resin and a ketimine. Mixtures of this kind are stable on storage in the absence of moisture. On application in the presence of moisture, the amine curing agent is liberated from the ketimine, and at the same time the crosslinking reaction of the alkoxysilyl groups is initiated. EP 0671437 observes that good performance properties are obtained only with silane-terminated polymers. EP 0794230 discloses one-component systems as in EP 0674137 that have improved storage stability through the addition of a carbonyl compound.

EP 1679329 describes specific one-component silyl polymer-epoxy resin systems which comprise selected ketimine compounds that derive from cyclohexanediamine. Only when epoxy resin is used at very high levels, based on the alkoxysilyl-terminated polymer, do the curable mixtures of EP 1679329 lead to the good mechanical strengths desired. It is necessary accordingly to use the epoxy resin at 70% to 500% by mass, based on the mass of alkoxysilyl-functional polymer. A high quantity of epoxide curing agent is needed, accordingly, for the overall mixture to have only low mass fractions of the silyl polymer in the system as a whole.

The state of the art is lacking curable systems which unite the positive properties of alkoxysilyl-functional polymers and epoxy resins with one another: High extensibility, elasticity and through-curing in conjunction with high adhesion to different substrates, high mechanical load-bearing capacity and stability. Such silyl polymer-epoxy resin combinations are additionally required to have sufficient storage stability and sufficiently easy processability and also, optionally, to be able to be used as one-component or two-component systems.

It is an object of the present invention, therefore, to provide curable mixtures which fulfil this balanced pattern of properties.

Surprisingly it has been found that compositions comprising a binder composition and a curing agent mixture as described in the claims overcome at least one disadvantage of the prior art.

The present invention provides curable mixtures comprising at least one binder composition (A) comprising

compound (a1) at least one silyl polyether which pendently has at least two alkoxysilyl groups, and

compound (a2) at least one epoxide compound and also at least one curing agent mixture (B) comprising

compound (b1) at least one curing catalyst for crosslinking the polyether pendently bearing alkoxysilyl groups and

compound (b2) at least one curing agent for the epoxide compound and

optionally one or more alkoxysilane compounds.

Preferred compounds (a1) are silyl polyethers which have an average preferably at least more than two, more preferably at least three, especially preferably more than three, three and up to 20 pendent alkoxysilyl groups.

The curable mixtures of the invention are preferably 2-component mixtures, comprising component (A) and component (B), which are mixed with one another only shortly before application, with component (A) corresponding to the binder composition (A) and with component (B) corresponding to the curing agent mixture (B), the optional alkoxysilane compound having been added beforehand to component (A) or to component (B).

Optionally, according to functionality and reactivity, the optional alkoxysilane compound may be accommodated either in component (A) or in component (B). This is also the case for any further constituents of the curable mixture.

The alkoxysilane compounds which have epoxide groups are preferably added to the component (A); in particular, alkoxysilane compounds which have no free amino groups, hence also not the imines defined below, are added preferably to the component (A).

The alkoxysilane compounds that have amino groups and imines are added preferably to the component (B).

Preferably 0.01 to 20 wt % of alkoxysilane compounds, based on the sum total by mass of alkoxysilane compounds plus component (A), preferably 0.5 to 15 wt %, are added to component (A).

The alkoxysilane compounds are preferably added either to component (A) or to component (B). More preferably the alkoxysilane compounds are added exclusively to component (B).

The 2-component mixtures are advantageous in that their handling is simple.

More preferably, the curable mixtures of the invention are 1-component mixtures, meaning that they already contain, as a mixture, component (A) and (B), and also, optionally, one or more alkoxysilane compounds.

Preferred compounds (a1) are silyl polyethers which carry on average at least three and up to 10 pendent alkoxysilyl groups and which are preparable by the method of alkoxylation of epoxide-functional alkoxysilanes by means of double metal cyanide (DMC) catalysts. These silyl polyethers are preferably prepared according to the method disclosed in EP 2093244 B1.

With further preference these silyl polyethers are compounds of the formula (1)

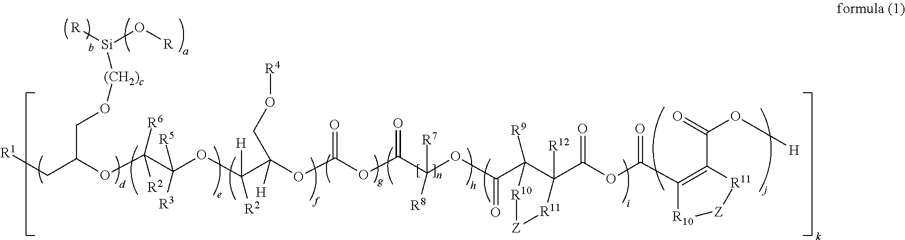

where
a is an integer from 1 to 3, preferably 3,
b is an integer from 0 to 2, preferably 0 to 1, more preferably 0, and the sum of a and b is 3,
c is an integer from 0 to 22, preferably from 1 to 12, more preferably from 2 to 8, very preferably from 3 to 4, and in particular is 1 or 3,
d is an integer from greater than 2 up to 500, preferably greater than 2 to 100, more preferably greater than 3 up to 20, and with more particular preference greater than 3 to 10,
e is an integer from 0 to 10 000, preferably 1 to 4000, more preferably 10 to 2000 and more particularly 20 to 500,
f is an integer from 0 to 1000, preferably 0 to 100, more preferably 0 to 50 and more particularly 0 to 30,
g is an integer from 0 to 1000, preferably 1 to 200, more preferably 2 to 100 and more particularly 3 to 70,
h, i and j independently of one another are integers from 0 to 500, preferably 0 to 300, more preferably 0 to 200 and more particularly 0 to 100,
n is an integer between 2 and 8, preferably 5,
k is an integer from 1 to 6, preferably 2 to 4,
R represents one or more identical or different radicals selected from linear or branched, saturated, mono- or polyunsaturated alkyl radicals having 1 to 20, more particularly 1 to 6, carbon atoms or haloalkyl groups having 1 to 20 carbon atoms. R corresponds preferably to methyl, ethyl, propyl, isopropyl, n-butyl and sec-butyl groups, especially methyl and ethyl, more particularly ethyl.
R¹ is a hydroxyl group or a k-functional radical, preferably a saturated or unsaturated linear, branched or cyclic or further-substituted oxyorganic radical having 1 to 1500 carbon atoms, it also being possible for the chain to be interrupted by heteroatoms such as O, S, Si and/or N, or is a radical comprising oxyaromatic system, or is an optionally branched, silicone-containing organic radical which has an oxygen for bonding to the fragment with the index k,
R² or R³, and also R⁵ or R⁶, identically or else independently of one another, are H or a saturated or optionally mono- or polyunsaturated, also further-substituted, optionally mono- or polyvalent hydrocarbon radical, preferably a methyl, ethyl, propyl or butyl, vinyl, allyl radical or phenyl radical, especially methyl, ethyl or phenyl, especially preferably methyl,
R⁴ corresponds to a linear or branched alkyl radical of 1 to 24 carbon atoms or to an aromatic or cycloaliphatic radical which may optionally in turn carry alkyl groups;
R⁷ and R⁸ are, independently of one another, either hydrogen or alkyl, alkoxy, aryl or aralkyl groups,
R⁹, R¹⁰, R¹¹ and R¹² are, independently of one another, either hydrogen or alkyl, alkenyl, alkoxy, aryl or aralkyl groups. The hydrocarbon radical may be bridged cycloaliphatically or aromatically by the fragment Z, in which case Z may represent a divalent alkylene radical or alkenylene radical,
with the proviso that the fragments with the indices d, e, f and/or h are freely permutable with one another, i.e. are mutually interchangeable within the polyether chain and are optionally present statistically and hence are mutually interchangeable in the sequence within the polymer chain.

Preference is given to those silyl polyethers of the formula (1) in which the sum of the indices d, i to j is 10 to 10 000, preferably 20 to 5000, more preferably 30 to 1000.

The polyethers of the formula (1) have a statistical construction. Statistical distributions are of blockwise construction with any desired number of blocks and with any desired sequence or are subject to a randomized distribution; they may also have an alternating construction or else form a gradient over the chain; more particularly they can also form any mixed forms in which groups with different distributions may optionally follow one another. The nature of specific embodiments can result in restrictions to the random distributions. In all regions unaffected by the restriction there is no change to the random distribution. Cyclic anhydrides and also carbon dioxide are inserted exclusively in randomized form, in other words not in homologous blocks.

The indices reproduced in the formulae given here, and the ranges of values for the indices stated, should be understood as the average values of the possible statistical distribution of the structures and/or mixtures thereof that are actually present. This also applies to structural formulae exactly reproduced per se as such.

In the context of the present invention the term polyether encompasses not only polyethers, polyetherols, polyether alcohols and polyether esters but also polyethercarbonates, which may be used synonymously with one another. At the same time, the term “poly” does not necessarily have to mean that there are a multiplicity of ether functionalities or alcohol functionalities in the molecule or polymer. Instead, this merely suggests the presence at least of repeat units of individual monomer units or else compositions that have a relatively high molar mass and additionally a certain polydispersity.

In connection with this invention, the word fragment “poly” encompasses not just exclusively compounds having at least 3 repeat units of one or more monomers in the molecule, but in particular also those compositions of compounds which have a molecular weight distribution and at the same time have a mean molecular weight of at least 200 g/mol. This definition takes account of the fact that it is customary in the field of industry in question to refer to such compounds as polymers even if they do not appear to conform to a polymer definition as per OECD or REACH guidelines.

R¹ is a fragment which originates from the starter or the starting compounds for the alkoxylation reaction.

The starting compounds have hydroxyl groups in a number corresponding at least to the index k.

OH-Functional starting compounds used are preferably compounds having molar masses of 18 to 10 000 g/mol, more particularly 50 to 2000 g/mol, and having 1 to 6, preferably 2 to 4, hydroxyl groups.

More preferably R¹ is a hydroxyl group or a k-functional, saturated or unsaturated, linear, branched or cyclic or further-substituted oxyorganic radical having 1 to 1500 carbon atoms, which optionally may also be interrupted by heteroatoms such as O, S, Si or N; more preferably R¹(—H)ₖ is a hydroxyalkyl-functional siloxane or a hydroxy-functional polyethersiloxane.

More preferably the starting compounds are selected from the group of the alcohols, polyetherols, hydroxyl-functional polyetheresters, hydroxyl-functional polyethercarbonates, hydroxyl-functional polybutadienes and hydrogenated hydroxyl-functional polybutadienes, or phenols having 1 to 6 hydroxyl groups and having molar masses of 50 to 5000 g/mol.

More preferably the starting compounds are selected from water, allyl alcohol, butanol, octanol, dodecanol, stearyl alcohol, 2-ethylhexanol, cyclohexanol, benzyl alcohol, ethylene glycol, 1,3-propylene glycol, di-, tri- and polyethylene glycol, 1,2-propylene glycol, di- and polypropylene glycol, 1,4-butanediol, 1,6-hexanediol, trimethylolpropane, glycerol, pentaerythritol, sorbitol, cellulose sugars, lignin or else other compounds which are based on natural substances and which carry hydroxyl groups. More preferably still, the starting compounds are selected from water, allyl alcohol, butanol, octanol, decanol, dodecanol, stearyl alcohol, 2-ethylhexanol, ethylene glycol, di-, tri- and polyethylene glycol, 1,2-propylene glycol, di- and polypropylene glycol, trimethylolpropane, glycerol, pentaerythritol. Especially preferred are allyl alcohol, butanol, octanol, polyethylene glycol, and polypropylene glycol. The radical R¹ corresponds more preferably still to the alcohol residues stated, in other words to the alcohols in which at least the hydrogen of a hydroxyl group is replaced by the fragment with the index k of the formula (1); with particular preference R¹ is butoxy, allyloxy, octyloxy, dodecyloxy, oxyethoxy, oxypropoxy, alpha,omega-bisoxypolyethylene glycol or alpha,omega-bisoxpolypropylene glycol.

As well as compounds with aliphatic and cycloaliphatic OH groups, any desired compounds having 1 to 6 phenolic OH functions are suitable. These include, for example, phenol, alkyl- and arylphenols, bisphenol A and novolacs.

The alkoxysilyl unit in the silyl polyethers of formula (1) is preferably a trialkoxysilyl unit, more preferably a triethoxysilyl unit.

More preferred are the pendently alkoxysilyl-bearing silyl polyethers for which a is 3, b is zero, c is an integer from 2 to 8, d is an integer from 2 to 10, e is an integer from 20 to 4000, the indices f, g, h, i and j are zero, k is an integer from 1 to 4, the radicals R are methyl or ethyl, R¹ is butoxy, allyloxy, alpha,omega-bisoxypolyethylene glycol or alpha,omega-bisoxypolypropylene glycol, the radicals R² or R³, and also R⁵ or R⁶, are identical or else independent of one another and are hydrogen or methyl.

Especially preferred are the pendently alkoxysilyl-bearing polymers for which a is 3, b is zero, c is an integer from 2 to 8, d is an integer from 3 to 10, e is an integer from 20 to 4000, the indices f, g, h, i and j are zero, k is an integer from 2 to 4, the radicals R are methyl or ethyl, R¹ is alpha,omega-bisoxypolyethylene glycol or alpha,omega-bisoxypolypropylene glycol and the radicals R² or R³, and also R⁵ or R⁶, are identical or else independent of one another and are hydrogen or methyl.

As shown by ²⁹Si-NMR and GPC investigations, the method-related presence of chain-end OH groups means that transesterification reactions on the silicon atom are possible not only during the DMC-catalysed preparation but also, for example, in a subsequent process step. In that case, formally, the alkyl residue R bonded to the silicon via an oxygen atom is replaced by a long-chain, modified alkoxysilyl polymer residue. Both bimodal and multimodal GPC plots demonstrate that the formula (1) gives only a simplified picture of the complex chemical reality.

The diversity of chemical structures and molar masses is also reflected in the broad molar mass distributions of M_{w}/Mₙ of usually ≥1.5, which are typical of silyl polyethers of the formula (1) and are completely unusual for conventional DMC-based polyethers.

Likewise preferred compounds (a1) are urethanized, pendently alkoxysilyl-modified silyl polyethers. More preferred are pendently alkoxysilyl-bearing polyethers which at the same time comprise urethane groups, and which have on average, based on the individual molecule, more than two pendent alkoxysilyl groups per urethane group. In subsequent reactions, the urethane groups may also be converted at least partly into allophanates, biuret groups and/or urea groups. These urethanized silyl polyethers are preparable by the process described in EP2289961 (US2011046305) by a reaction of isocyanates with the hydroxyl-functional silyl polyethers of the formula (1). More preferably the urethanized silyl polyethers are prepared by the process disclosed in EP2289961 (US2011046305).

These urethanized silyl polyethers are notable advantageously for their relatively high alkoxysilyl functionality and hence for the possibility of setting the crosslinking density and through-curing in a controlled way and within wide limits. In this way, the disadvantages described for silane-terminated polymers and for prior-art pendently alkoxysilyl-modified polymers used to date are avoided.

The urethanized silyl polyethers preferably comprise the catalyst and/or residues thereof from the urethanization reaction, with this catalyst and its residues being present more preferably in the crosslinking reaction of the alkoxysilyl-bearing polyethers and of the curing agents of the epoxide groups, in an amount which is not capable of taking over the function of the compound (b2); more preferably still, the urethanized silyl polyethers contain the catalyst in not more than one tenth of the required amount of compound (b2).

More preferably the urethanized silyl polyethers are preparable as reaction products of the reaction of

x1) at least one silyl polyether of the formula (1),

x2) with at least one compound which has one or more isocyanate groups,

x3) optionally in the presence of one or more catalysts,

x4) optionally in the presence of further components reactive towards the reaction products, more particularly components which possess functional groups having protic hydrogen, for example alcohols, amines, thiols, polyetherols, alkoxysilanes and/or water.

Preferred as compounds x2) containing isocyanate groups are all known isocyanates. More preferred are aromatic, aliphatic and cycloaliphatic polyisocyanates having a number-average molar mass of below 800 g/mol. More preferable still are diisocyanates selected from 2,4-/2,6-toluene diisocyanate (TDI), methylenediphenyl diisocyanate (MDI), triisocyanatononane (TIN), naphthyl diisocyanate (NDI), 4,4″-diisocyanatodicyclohexylmethane, 3-isocyanatomethyl-3,3,5-trimethylcyclohexyl isocyanate (isophorone diisocyanate=IPDI), tetramethylene diisocyanate, hexamethylene diisocyanate (HDI), 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3″-dimethyldicyclohexylmethane, 2,2-bis(4-isocyanatocyclohexyl)propane, 3-isocyanatomethyl-1-methyl-1-isocyanatocyclohexane (MCI), 1,3-diisooctylcyanato-4-methylcyclohexane, 1,3-diisocyanato-2-methylcyclohexane and α,α,α′,α′-tetramethyl-m- or -p-xylylene diisocyanate (TMXDI), and also mixtures consisting of these compounds. Especially preferred are hexamethylene diisocyanate (HDI), isophorone diisocyanate (IPDI) and/or 4,4′-diisocyanatodicyclohexylmethane.

Where the compound x2) containing isocyanate groups is used in a molar excess relative to the OH groups of the silyl polyether component, reactive prepolymers are formed which terminally carry NCO groups. Compounds with isocyanate-reactive groups can be added on to these NCO groups. For example, mono- or polyhydric alcohols, mono- and polyfunctional amines, thiols, OH-functional alkoxysilanes, aminoalkoxysilanes, amino-functional polymers, polyetherols, polyols, polyesterols, acrylated alcohols such as hydroxyethyl acrylate, and silicone-polyether copolymers having OH-functional polyether radicals can be introduced.

When an excess of the OH-functional silyl polyether of the formula (1) is used, relative to the NCO groups of the isocyanate component, urethanized polyols are formed which carry alkoxysilyl groups and have terminal OH groups. These urethanized alkoxysilyl polymers can be modified with isocyanates on their OH groups. At its most simple, this involves reaction of alkyl, aryl and/or arylalkyl monoisocyanates with the OH groups of the silyl polyether, with formation of the respective adduct and, at the same time, with end-capping of the reactive chain end of the silyl polyether used. Suitable for this purpose for example are methyl, ethyl, butyl, hexyl, octyl, dodecyl and stearyl isocyanate.

Particularly preferred monofunctional isocyanates are those which in turn have crosslinkable alkoxysilyl groups in the molecule. These include, preferably, isocyanatoalkyl-trialkoxysilanes and isocyanatoalkyl-alkyldialkoxysilanes.

Preferred alkoxysilane-functional monoisocyanates used are (isocyanatomethyl)trimethoxysilane, (isocyanatomethyl)triethoxysilane, (isocyanatomethyl)methyldimethoxysilane, (isocyanatomethyl)methyldiethoxysilane, (3-isocyanatopropyl)trimethoxysilane, (3-isocyanatopropyl)methyldimethoxysilane, (3-isocyanatopropyl)triethoxysilane and (3-isocyanatopropyl)methyldiethoxysilane. More preferred are (3-isocyanatopropyl)trimethoxysilane and triethoxysilane.

Preferred compounds (a2) are the epichlorohydrin-derived glycidyl ethers, glycidyl esters and glycidylamines, more preferably bisphenol A diglycidyl ether, bisphenol F diglycidyl ether, glycidyl ethers of novolaks (epoxy-novolak resins), hydrogenated bisphenol A diglycidyl ether, hydrogenated bisphenol F diglycidyl ether, phenyl glycidyl ether, cresyl glycidyl ether, tert-butyl glycidyl ether, diglycidylaniline, tetraglycidylmethylenedianiline, triglycidylaminophenol, 1,6-hexane diglycidyl ether, 1,4-butane diglycidyl ether, cyclohexanedimethyl diglycidyl ether, alkyl glycidyl ethers, benzyl glycidyl ether, trimethylolpropane triglycidyl ether, pentaerythritol tetraglycidyl ether, brominated glycidyl ethers such as tetrabromobisphenol A diglycidyl ether, alkyl glycidyl esters, triglycidyl isocyanurate, allyl glycidyl ether, poly(alkylene glycol) diglycidyl ethers, and epoxide compounds of unsaturated hydrocarbons and unsaturated fats and/or fatty acids. Likewise preferred are oligomeric and polymeric epoxide compounds selected from epoxide-carrying polyolefins and siloxanes, or epoxide compounds formed by chain extension preferably from diglycidyl ethers with OH-functional compounds. Particularly preferred are epoxide compounds having two or more than two epoxide groups per molecule.

The compound (a1) and the compound (a2) are used preferably in a mass ratio of 100/1 to 1/100. Preferably the mass ratio is 100/5 to 20/100. It may be advantageous to combine mixtures of two or more epoxide compounds (a2) and also mixtures of two or more pendently alkoxysilyl-bearing silyl polyethers (a1) in order to establish particular profiles of properties.

The compound (b1) is preferably a catalyst selected from hydrolysis/condensation catalysts for alkoxysilanes, organic tin compounds, tetraalkylammonium compounds, guanidine compounds, guanidine-siloxane compounds and bismuth catalysts.

Preferred compound (b1) are the hydrolysis/condensation catalysts for alkoxysilanes that are known to the skilled person. Preferred curing catalysts used are organic tin compounds, such as, for example, dibutyltin dilaurate, dibutyltin diacetylacetonate, dibutyltin diacetate, dibutyltin dioctoate, or dioctyltin dilaurate, dioctyltin diacetylacetonate, dioctyltin diketanoate, dioctylstannoxane, dioctyltin dicarboxylate, dioctyltin oxide, preferably dioctyltin diacetylacetonate, dioctyltin dilaurate, dioctyltin diketanoate, dioctylstannoxane, dioctyltin dicarboxylate, dioctyltin oxide, more preferably dioctyltin diacetylacetonate and dioctyltin dilaurate. Also used, furthermore, may be zinc salts, such as zinc octoate, zinc acetylacetonate and zinc-2-ethylcaproate, or tetraalkylammonium compounds, such as N,N,N-trimethyl-N-2-hydroxpropylammonium hydroxide, N,N,N-trimethyl-N-2-hydroxypropylammonium 2-ethylhexanoate or choline 2-ethylhexanoate. Preference is given to the use of zinc octoate (zinc 2-ethylhexanoate) and of the tetraalkylammonium compounds, particular preference to that of zinc octoate. Further preferred are bismuth catalysts, e.g. Borchi® catalysts, titanates, e.g. titanium(IV) isopropoxide, iron(III) compounds, e.g. iron(III) acetylacetonate, aluminium compounds, such as aluminium triisopropoxide, aluminium tri-sec-butoxide and other alkoxides and also aluminium acetylacetonate, calcium compounds, such as calcium disodium ethylenediaminetetraacetate or calcium diacetylacetonate, or else amines, examples being triethylamine, tributylamine, 1,4-diazabicyclo[2.2.2]octane, 1,8-diazabicyclo[5.4.0]undec-7-ene, 1,5-diazabicyclo[4.3.0]non-5-ene, N,N-bis(N,N-dimethyl-2-aminoethyl)methylamine, N,N-dimethylcyclohexylamine, N,N-dimethylphenylamine, N-ethylmorpholine, etc. Additionally, organic or inorganic BrØnsted acids such as acetic acid, trifluoroacetic acid, methanesulphonic acid, p-toluenesulphonic acid or benzoyl chloride, hydrochloric acid, phosphoric acid and the monoesters and/or diesters thereof, such as butyl phosphate, (iso)propyl phosphate, dibutylphosphate, etc., are examples of preferred catalysts. Further preferred are organic and organosilicon compounds that carry guanidine groups. It is of course also possible to employ combinations of two or more catalysts.

Furthermore, photolatent bases as well may be used as catalysts, of the kind described in WO 2005/100482.

The curing catalyst (b1) is used in amounts of 0.1 to 5.0 wt %, preferably 0.2 to 4.0 wt % and more preferably 0.5 to 3 wt %, based on the sum total by mass of component (A), of the compound (b1) and of the optional alkoxysilane compounds.

Preferred compounds (b2) are amines or imines, where the amines carry as active nitrogen at least one hydrogen on the nitrogen, and where the imines have as their active nitrogen no hydrogen but instead a C═N double bond.

Preferred compounds (b2) are all compounds having at least one primary or secondary amine group. Preferred amines are those having at least two hydrogens N—H that are reactive towards epoxide groups per molecule. More preferred are ethylenediamine, 1,6-diaminohexane, diaminocyclohexane, isophoronediamine, trimethyl-1,6-hexanediamine, m-xylylenediamine, diaminodiphenylmethane, diethylenetriamine, triethylenetetramine, tetraethylenepentamine, pentaethylenehexamine, N-aminoethylpiperazine, polyoxyalkylenepolyamines, aminosiloxanes, aminosilanes, polyethyleneimine. Further preferred are the adduct curing agents known to the skilled person, formed by addition of a polyamine onto an epoxide compound, and also the group of the polyaminoamides and polyaminoimidazolines, which are prepared from polyamines and carboxylic acids, especially fatty acids. More preferred are mixtures of amines.

The amount of compound (b2) used is guided by the amount of epoxide compound (a2) in the curable mixtures. The molar ratio of epoxide groups of the compounds (a2) to reactive N—H groups of the amines or active nitrogens in imines of the compounds (b2) is preferably between 2:1 to 1:3, preferably between 1.5:1 to 1:2; approximately stoichiometric ratios of 1.2:1 to 1:1.5 are particularly preferred.

The curing reaction begins immediately after the combining of the epoxide compound with compound (b2), where the latter has free amino groups, independently of the presence of moisture.

Consequently, the curable mixtures of the invention in the 2-component systems are applied immediately after the components have been mixed, and are then not stable on storage.

Preference is given to using imines with active nitrogen as compound (b2) for preparing 1-component systems. The curable mixtures of the invention as 1-component systems have the advantage that they are stable on storage, since the crosslinking reaction of the compounds (a1) is controlled by the presence of water, and hence water-free systems, even when all of the components have been mixed, do not crosslink in the absence of moisture.

Imines as compound (b2) preferably comprise at least one structural element of the formula (2)

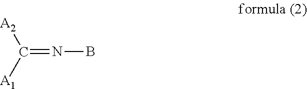

where

A₁ and A₂ independently of one another are hydrogen or an organic radical, the radicals A₁ and A₂ originating preferably from the condensation reaction (i.e. a reaction with elimination of one equivalent of water) of an amine-functional compound B—NH₂ with a carbonyl compound A₁-C(═O)-A₂ and therefore preferably correspond to the radicals of the carbonyl compound used, it being the case that, if the radicals originate from a compound which has a keto function, both radicals A₁ and A₂ are each an organic radical and, if the radicals originate from a compound which has an aldehyde function, at least one of the two radicals A₁ and A₂ is an organic radical and the other of the radicals is hydrogen in each case, and B is any organic radical or an organomodified siloxane or silane radical. A₁ and A₂ may be part of a ring and may be linked to one another by an organic radical.

Depending on the nature of the radicals A₁ and A₂, such compounds are often also termed ketimines or Schiffs bases. More preferably the imines have two or more imine groups in the molecule. The imines used in accordance with the invention may contain radicals of the reactants, if, for example, one of the starting materials was used in a molar excess or if the condensation reaction had not proceeded to completion.

Aldehydes and/or ketones used are preferably acetaldehyde, propionaldehyde, butyraldehyde, benzaldehyde, cinnamaldehyde, salicylaldehyde, toluene aldehyde, anisaldehyde, acrolein, crotonaldehyde, acetone, methyl ethyl ketone, ethyl butyl ketone, ethyl n-propyl ketone, methyl isobutyl ketone, methyl amyl ketone, diethyl ketone, methyl isopropyl ketone, methyl n-propyl ketone, diisopropyl ketone, diisobutyl ketone, methyl pentyl ketone, cyclohexanone, cyclopentanone, acetophenone, benzophenone and/or isophorone. Particular preference is given to using those aldehydes and/or ketones from the list above that have a boiling point of more than 80° C., preferably more than 100° C., since in curable mixtures of the invention they exhibit outstanding storage stabilities. Especially preferred are 2-heptanone, benzaldehyde, methyl isobutyl ketone, cyclohexanone, anisaldehyde and/or cinnamaldehyde.

In principle it is possible to use all compounds having at least one primary amine group for preparing the imine compounds. Preferred amines are those having at least two primary amine groups —NH₂ per molecule. More preferred are amines having two amine groups, selected from ethylenediamine, 1,6-diaminohexane, diaminocyclohexane, isophoronediamine, trimethyl-1,6-hexanediamine, m-xylylenediamine, diaminodiphenylmethane, diethylenetriamine, triethylenetetramine, pentaethylenehexamine, N-aminoethylpiperazine, polyoxyalkylenepolyamines, aminosiloxanes, aminosilanes, polyethyleneimine.

In the absence of water, the imines of the formula (2) represent latent amine curing agents. Only in the presence of water do they split back into the carbonyl compound and the respective amine, and trigger the curing reaction with the epoxide groups. They are therefore suitable with preference for the preparation of curable 1-component systems of the invention.

As curing agents it is possible as well, in addition to amines, to use other compounds that are reactive towards epoxides. These include, for example, mercapto compounds, anhydrides, and also compounds carrying carboxyl groups and phenolic OH groups.

The curable mixtures of the invention optionally comprise one or more alkoxysilane compounds. These alkoxysilane compounds are preferably monomeric silanes and/or polymer-bonded silanes which carry methoxy, ethoxy, i-propoxy, n-propoxy or butoxy, aryloxy or acetoxy groups as hydrolysable groups. The non-hydrolysable radical is arbitrary. The non-hydrolysable radical is preferably an organic radical which is functionalized with a group that is reactive towards amines and/or epoxides. This is the pathway by which the silanes participate in the crosslinking reaction and link the resultant polymer networks to one another. Furthermore, these silanes exert a beneficial effect as adhesion promoters. The alkoxysilane compounds are not silyl polyethers of the formula (1).

Particularly advantageous is the use of, for example, 3-glycidyloxypropyltrimethoxysilane (Dynasylan® GLYMO, Evonik), 3-glycidyloxypropyltriethoxysilane (Dynasylan® GLYEO, Evonik), 3-glycidyloxypropyl(methyl)dimethoxysilane, 3-glycidyloxypropyl(methyl)diethoxysilane, 2-(3,4-epoxycyclohexyl)ethyltrimethoxysilane, 2-(3,4-epoxycyclohexyl)ethyltriethoxysilane, N-cyclohexylaminomethyltrimethoxysilane, N-cyclohexyl-3-aminopropyltriethoxysilane, 3-aminopropyltrimethoxysilane (Dynasylan® AMMO, Evonik), 3-aminopropyltriethoxysilane (Geniosil® GF 93, Wacker, Dynasylan® AMEO, Evonik), 3-aminopropyl(methyl)dimethoxysilane, 3-aminopropyl(methyl)diethoxysilane, N-(2-aminoethyl)-3-aminopropyltrimethoxysilane (Dynasylan® DAMO, Evonik), N-(n-butyl)aminopropyltrimethoxysilane (Dynasylan® 1189, Evonik), (3-aminopropyl)methyldiethoxysilane (Dynasylan® 1505, Evonik), trimethoxypropylsilane (Dynasylan 1146, Evonik).

The curable mixtures of the invention, as storage-stable 1-component systems, more preferably have imine-modified aminosilanes which in the absence of moisture do not react with epoxides. Preferred imine-functionalized silanes are those deriving from 3-aminopropyltrimethoxysilane (Dynasylan® AMMO), 3-aminopropyltriethoxysilane (Geniosil® GF 93, Dynasylan® AMEO), 3-aminopropyl(methyl)dimethoxysilane, 3-aminopropyl(methyl)diethoxysilane, (3-aminopropyl)methyldiethoxysilane (Dynasylan® 1505). Imine-modified silanes which in the sense of this invention enable mixtures which are storage-stable in the presence of epoxides and pendently alkoxysilyl-bearing polyethers are disclosed in WO2015/003875.

Also possible for use are mercapto-functional silanes such as, for example, mercaptopropyltrimethoxysilane and mercaptopropyltriethoxysilane.

The monomeric alkoxysilanes optionally present in the curable mixtures of the invention may be added optionally individually or in combination of two or more silanes to the curable mixtures.

The alkoxysilane compounds included optionally in the curable mixtures of the invention are preferably included at from 0.01 to 20 wt %, more preferably from 0.5 to 15 wt % and especially preferably from 1 to 10 wt %, based on the pendently alkoxysilyl-bearing silyl polyether a1).

Besides the components (A) and (B) and optionally alkoxysilane compounds, the curable mixtures of the invention preferably comprise further additives selected from the group of plasticizers, fillers, solvent, adhesion promoters, rheological additives, stabilizers, catalysts, solvents and dryers, especially chemical moisture dryers.

The curable mixture of the invention preferably comprises one or more adhesion promoters and/or one or more dryers, especially chemical moisture dryers.

It may be advantageous if the curable mixture of the invention has a dryer, for the purpose, for example, of binding moisture or water which is introduced by components of the formulation or which is incorporated subsequently as a result of the dispensing operation or the storage process. Dryers which can be used in the curable mixtures of the invention are in principle all dryers known from the prior art. Preferred as chemical dryer are vinyltrimethoxysilane (Dynasylan® VTMO, Evonik or Geniosil® XL 10, Wacker), vinyltriethoxysilane (Dynasylan® VTEO, Evonik or Geniosil® GF 56, Wacker), N-trimethoxysilylmethyl-O-methylcarbamate (Geniosil® XL 63, Wacker), N-dimethoxy(methyl)silylmethyl-O-methylcarbamate, N-methyl[3-(trimethoxysilyl)propyl]carbamate (Geniosil® GF 60, Wacker), vinyldimethoxymethylsilane (Geniosil® XL 12, Wacker), vinyltris(2-methoxyethoxy)silane (Geniosil® GF 58, Wacker), bis(3-triethoxysilylpropyl)amine (Dynasylan® 1122, Evonik), bis(3-trimethoxysilylpropyl)amine (Dynasylan® 1124), N-dimethoxy(methyl)silylmethyl-O-methyl-carbamate (Geniosil® XL 65, Wacker) or oligomeric vinylsilanes such as, for example, Dynasylan® 6490 and Dynasylan® 6498 (both acquirable from Evonik), on their own or as mixtures. More preferred are the dryers selected from vinyltrimethoxysilane (Dynasylan® VTMO, Evonik or Geniosil® XL 10, Wacker AG), vinyltriethoxysilane (Dynasylan® VTEO, Evonik or Geniosil® GF 56, Wacker). It may be advantageous, furthermore, if additionally or alternatively to the chemical drying there is a physical dryer used, such as preferably zeolite, molecular sieve, anhydrous sodium sulphate or anhydrous magnesium sulphate.

The fraction of the dryers in the curable mixtures of the invention is preferably from greater than 0 to 5 wt %, more preferably from 0.2 to 3 wt %, based on the amount of the pendently alkoxysilyl-bearing silyl polyethers a1) used.

Plasticizers are preferably selected from the group of phthalates, polyesters, alkylsulphonic esters of phenol, cyclohexanedicarboxylic esters, benzoates, dipropylene glycol dibenzoates, petroleum distillates or else polyethers which contain no alkoxysilyl groups and no epoxide groups.

If plasticizers are present in the curable mixtures of the invention, the fraction of the plasticizers in the overall composition of the invention is preferably from greater than 0 wt % to 90 wt %, more preferably 2 wt % to 70 wt %, very preferably 5 wt % to 50 wt %, based on the overall composition.

Fillers are preferably precipitated or ground chalk, inorganic carbonates in general, precipitated or ground silicates, precipitated or fumed silicas, glass powders, hollow glass beads (called bubbles), metal oxides, such as TiO₂, Al₂O₃, natural or precipitated barium sulphates, finely ground quartzes, sand, aluminium trihydrates, talc, mica, fine ground cristobalites, reinforcing fibres, such as glass fibres or carbon fibres, long-fibre or short-fibre wollastonites, cork, carbon black or graphite. With advantage it is possible to use hydrophobized fillers, since these products exhibit lower introduction of water and improve the storage stability of the formulations.

If fillers are present in the curable mixtures of the invention, the fraction of the fillers in the curable mixture of the invention is preferably from 1 to 80 wt %, based on the overall composition, with concentrations of 30 to 65 wt % being particularly preferred for the fillers specified here, except for the fumed silicas. If fumed silicas are used, a fumed silicas fraction of 2 to 20 wt % is particularly preferred.

As rheological additives, included preferably in addition to the filler, selection may be made from the group of the amide waxes, obtainable for example from Arkema under the brand name Crayvallac®, hydrogenated vegetable oils and fats, fumed silicas, such as Aerosil® R202, Aerosil® R974 or Aerosil® R805 (Evonik) or Cab-O-Sil® TS 720 or TS 620 or TS 630 (Cabot). If fumed silicas are already present as filler, then preferably no rheological additive is added.

If rheological additives are present in the curable mixtures of the invention, the fraction of the rheological additives in the curable mixture of the invention, depending on the desired flow characteristics, is preferably from greater than 0 wt % to 10 wt %, more preferably from 2 wt % to 6 wt %, based on the overall composition.

The curable mixtures of the invention may comprise solvents. These solvents may serve, for example, to lower the viscosity of the uncrosslinked mixtures, or may promote flow onto the surface. Solvents contemplated include in principle all solvents and also solvent mixtures. Preferred examples of such solvents are ethers such as tert-butyl methyl ether, esters, such as ethyl acetate or butyl acetate or diethyl carbonate, and also alcohols, such as methanol, ethanol and also the various regioisomers of propanol and butanol, or else types of glycols which are selected according to the specific application. Additionally it is possible for aromatic and/or aliphatic solvents to be used, such as benzene, toluene or n-hexane, or else halogenated solvents, such as dichloromethane, chloroform, tetrachloromethane, hydrofluorocarbons (FREON), etc., but also inorganic solvents such as CS₂, supercritical CO₂, etc., as examples.

As and when required, the curable mixtures of the invention may further comprise one or more substances selected from the group encompassing co-crosslinkers, flame retardants, deaerating agents, curing accelerators for the amine-epoxide reaction, antimicrobial and preservative substances, dyes, colorants and pigments, anti-freeze agents, fungicides and/or reactive diluents and also complexing agents, spraying assistants, wetting agents, fragrances, light stabilizers, radical scavengers, UV absorbers and stabilizers, especially stabilizers to counter thermal and/or chemical exposures and/or exposures caused by ultraviolet and visible light.

UV stabilizers are preferably known products based on hindered phenolic systems or benzotriazoles. Light stabilizers used may be, for example, those known as HALS amines. Examples of stabilizers which can be used are the products or product combinations known to the skilled person, comprising for example Tinuvin® stabilizers (BASF), such as Tinuvin® stabilizers (BASF), as for example Tinuvin® 1130, Tinuvin® 292 or else Tinuvin® 400, preferably Tinuvin® 1130 in combination with Tinuvin® 292. The amount in which they are used is guided by the degree of stabilization required.

Based on the binder mixture (A), the curable mixtures of the invention preferably have 10 to 90 wt %, more preferably 20 to 80 wt %, of compounds (a1), with compounds a1) having preferably on average between greater than 1 and up to 4 trialkoxysilyl functions per silyl polyether of the formula (1). More preferably the curable mixtures of the invention, based on the binder mixture (A), have 20 to 80 wt % of compounds (a1), with compounds (a1) preferably having on average between greater than 1 and up to 4 triethoxysilyl functions per silyl polyether of the formula (1).

Even more preferred as compounds (a1) are urethanized silyl polyethers, more preferably urethanized silyl polyethers which have on average between greater than 1 and up to 4 trialkoxysilyl functions per silyl polyether of the formula (1). Especially preferred as compounds (a1) are urethanized silyl polyethers, more preferably urethanized silyl polyethers which have on average between greater than 1 and up to 4 triethoxysilyl functions per silyl polyether of the formula (1).

The curable mixtures of the invention preferably have no compounds (a1) which have methoxysilyl functions.

The curable mixtures of the invention preferably have the following components:
binder composition (A) from 10 to 85 wt %, based on the overall composition, preferably from 15 to 60 wt % and more particularly from 20 to 50 wt %,
curing agent mixture (B) from 0.1 to 15 wt %, preferably 0.5 to 12 wt % and more particularly 1 to 8 wt %, based on the overall composition,
alkoxysilane compound from 0 to 5 wt %, preferably 0.5 to 4 wt %, especially preferably 0.8 to 3 wt %, based on the overall composition,
plasticizers from 0 to 30 wt %, preferably 5 to 25 wt %, based on the overall composition,
fillers from 1 to 80 wt %, preferably 5 to 70 wt %, especially preferably 10 to 60 wt %, based on the overall composition,
chemical dryers from 0 to 3.0 wt %, preferably 0.2 to 2.5 wt %, based on the overall composition.

An alternative preferred curable mixture of the invention with increased epoxide fraction has the following components:
binder composition (A) from 30 to 80 wt %, based on the overall composition, preferably from 35 to 75 wt % and more particularly from 40 to 70 wt %, with the binder composition (A) comprising a fraction of 20 to 90 wt %, preferably 30 to 80 wt %, more preferably 40 to 70 wt % of epoxide compound a2 in the binder composition (A),
curing agent mixture (B) from 1 to 30 wt %, preferably 2 to 25 wt % and more particularly 4 to 20 wt %, based on the overall composition,
alkoxysilane compound from 0 to 5 wt %, preferably 0.5 to 4 wt %, especially preferably 0.8 to 3 wt %, based on the overall composition,
plasticizers from 0 to 40 wt %, preferably 2 to 35 wt %, based on the overall composition,
fillers from 1 to 60 wt %, preferably 5 to 50 wt %, especially preferably 10 to 40 wt %, based on the overall composition,
chemically dryers from 0 to 3.0 wt %, preferably 0.2 to 2.5 wt %, based on the overall composition.

For especially preferred curable mixtures, the stated fractions of the formulation ingredients are selected such that the total sum of the fractions adds up to 100 wt %.

The invention further provides for the use of the curable mixtures of the invention comprising the binder mixture (A), the curing agent mixture (B) and optionally the alkoxysilane compounds.

The curable mixtures of the invention are used preferably as sealant or adhesive or for producing a sealant or adhesive.

The curable mixtures of the invention are used preferably as reactive diluents, primers, priming coats, barrier seals or roof coatings.

It is an advantage of the mixtures of the invention that even in relatively thick layers and also when applied over large areas, they undergo through-curing very well within a short time.

A further advantage is that the adhesion properties on various substrates such as, for example, steel, aluminium, various plastics and mineral substrates such as stone, concrete and mortar, for example, are improved relative to comparable systems without addition of epoxide.

The curable mixtures of the invention may be used in particular for reinforcing, levelling, modifying, adhesively bonding, for coatings, for the sealing and/or coating of substrates. Suitable substrates are, for example, particulate or sheetlike substrates, in the construction industry or in vehicle construction, structural elements, components, metals, especially construction materials such as iron, steel, stainless steel and cast iron, ceramic materials, especially based on solid metal oxides or non-metal oxides or carbides, aluminium oxide, magnesium oxide or calcium oxide, mineral or organic substrates, especially cork and/or wood, mineral substrates, chipboard and fibreboard made from wood or cork, composite materials such as, for example, wood composite materials such as MDF boards (medium-density fibreboard), WPC articles (wood plastic composites), chipboard, cork articles, laminated articles, ceramics, and also natural fibres and synthetic fibres (and substrates comprising them) or mixtures of different substrates. With particular preference the mixtures of the invention are used in the sealing and/or coating of particulate or sheetlike substrates, in the construction industry or in vehicle construction, for the sealing and adhesive bonding of structural elements and components, and also for the coating of porous or non-porous, particulate or sheetlike substrates, for the coating and modification of surfaces and for applications on metals, especially on construction materials such as iron, steel, stainless steel and cast iron, for application on ceramic materials, especially based on solid metal oxides or non-metal oxides or carbides, aluminium oxide, magnesium oxide or calcium oxide, on mineral substrates or organic substrates, especially on cork and/or wood, for the binding, reinforcing and levelling of uneven, porous or fractious substrates, such as mineral substrates, for example, chipboard and fibreboard made from wood or cork, on composite materials such as, for example, on wood composites such as MDF boards (medium-density fibreboards), WPC articles (wood plastic composites), chipboard, cork articles, laminated articles, ceramics, and also natural fibres and synthetic fibres, or mixtures of different substrates.

A further advantage of the mixtures of the invention is that they are also suitable for the adhesive bonding of combinations of materials composed of the substrates identified above.

Another advantage is that it is not essential whether the surfaces are smooth or roughened or porous. Roughened or porous surfaces are preferred, on account of the greater area of contact with the adhesive.

The mixtures of the invention are applied preferably in a temperature range of 10° C.-40° C. and even under these conditions they cure well. On account of the moisture-dependent curing mechanism, a relative atmospheric humidity of min. 35% to max. 75% is particularly preferred for effective curing. The cured adhesive bond (composition) can be used in a temperature range from −10° C. to 80° C.

Storage-stable and user-friendly 1-component systems are obtained if imines as per formula (2) are used instead of the amine curing agents with reactive N—H groups. These imines represent latent, capped amines, which only after the curable mixture has been discharged, from a cartridge, for example, on contact with humidity, undergo transition to form the respective amine and trigger the epoxide curing reaction. When imines are used as compound (b2), all of the ingredients of the mixtures of the invention can be mixed in the absence of moisture and introduced as a fully formulated adhesive/sealant composition into cartridges, for example. In the production of these 1-component systems, care must be taken to ensure the drying of all ingredients and apparatuses.

Preferred in the sense of the invention and for increasing the stability on storage is the use of imine-modified aminosilanes.

The subject-matter of the invention is described by way of example hereinafter, without any intention that the invention be restricted to these illustrative embodiments. When ranges, general formulae or compound classes are specified hereinafter, these shall include not just the corresponding ranges or groups of compounds that are explicitly mentioned but also all sub-ranges and sub-groups of compounds which can be obtained by extracting individual values (ranges) or compounds. When documents are cited in the context of the present description, the contents thereof, particularly with regard to the subject-matter that forms the context in which the document has been cited, are considered in their entirety to form part of the disclosure-content of the present invention. Unless stated otherwise, per centages are figures in percent by weight. When average values are reported hereinbelow, the values in question are weight averages, unless stated otherwise. When parameters which have been determined by measurement are reported hereinafter, they have been determined at a temperature of 25° C. and a pressure of 101.325 Pa, unless stated otherwise.

### EXAMPLES

### General Methods

The viscosity was determined shear rate-dependently at 25° C. with the MCR301 rheometer from Anton Parr in a plate/plate arrangement with a gap width of 1 mm. The diameter of the upper plate was 40 mm. The viscosity at a shear rate of 10 s⁻¹ was read off and is set out in Tables 2 and 3.

GPC measurements for determining the polydispersity and average molar masses were carried out under the following measuring conditions: Column combination SDV 1000/10 000 Å (length 65 cm), temperature 30° C., THF as mobile phase, flow rate 1 ml/min, sample concentration 10 g/l, RI detector, evaluation against polypropylene glycol standard (6000 g/mol).

The NCO content in percent was determined by back-titration with 0.1 molar hydrochloric acid following reaction with dibutylamine in accordance with DIN EN ISO 11909.

### Pendently Alkoxysilyl-Modified Polyethers:

The examples below used the following silyl polyethers 1, containing trialkoxysilyl groups, which had been prepared in accordance with EP 2093244 B1 by the process principle of the DMC-catalysed alkoxylation of 3-glycidyloxypropyltriethoxysilane (Dynasylan® GLYEO) from Evonik Degussa GmbH.

### Example 1: Syntheses

### Silylpolyether SP 1 (Pendently Alkoxysilyl-Functional Polyether):

A 5 litre autoclave was charged with 353 g of polypropylene glycol with an average molar mass of 2000 g/mol and this initial charge was admixed with 150 ppm (based on the total batch) of a zinc hexacyanocobaltate double metal cyanide catalyst. The reactor was inertized by injecting nitrogen to 3 bar and subsequent decompression to standard pressure. This operation was repeated twice more. While stirring, the contents of the reactor were heated to 130° C. and evacuated to about 20 mbar to remove volatile components. After 30 minutes, the catalyst was activated by the metered introduction into the evacuated reactor of 80 g of propylene oxide. The internal pressure rose initially to about 0.8 bar. After about 6 minutes there was onset of reaction, as evident from a drop in the reactor pressure. 1218 g of propylene oxide were then metered in continuously over about 50 minutes. This was followed by a one-hour after-reaction, during which the temperature was lowered to 95° C. At this temperature, a mixture of 196 g of Dynasylan® GLYEO (from Evonik) and 1233 g of propylene oxide was metered in continuously at a rate such that the temperature remained constant. After a further one-hour after-reaction, deodorization was carried out by application of a pressure (p<100 mbar) in order to remove residues of unreacted alkylene oxide. Then 500 ppm of Irganox® 1135 (from BASF) were stirred in for 15 minutes. This gave a colourless, viscous product (12 100 mPas at 25° C.) having on average 4 mol of triethoxysilyl groups and 2 OH groups per molecule and a polydispersity M_{w}/Mₙ of 2.4.

### Silylpolyether SP 2 (Urethane-Modified, Pendently Alkoxysilyl-Functional Polyether; According to De 102012203737):

706.8 g of silyl polyether from Example 1 were introduced and heated to 60° C. Then 26.68 g of IPDI were added, the mixture was stirred for five minutes, and 0.08 g of TIB Kat 216 (dioctyltin dilaurate) were added. The mixture was stirred for 45 minutes and heated to 80° C. and 53.5 g of a polyether of the general formula C₄H₉O[CH₂CH(CH₃)O]_{5.6}H were added. This was followed by stirring for 3 hours. The product had a viscosity of 72 000 mPas at 25° C. and a polydispersity M_{w}/Mₙ of 5.2.

### Silylpolyether SP 3 (Pendently Alkoxysilyl-Functional Polyether Ester):

A 5 litre autoclave was charged with 125 g of polycaprolactone (diol) from Perstorp with an average molar mass of 1250 g/mol and this initial charge was admixed with 100 ppm (based on the total batch) of a zinc hexacyanocobaltate double metal cyanide catalyst. As described in Example SP 1, the reactor was inertized and volatile components were removed by degassing. The catalyst was activated by the metering of 60 g of propylene oxide into the evacuated reactor at 130° C. Following the onset of the reaction, 210 g of propylene oxide were metered in continuously over about 65 minutes, followed by a 10 minute after-reaction and subsequently by the metered addition of a mixture of 400 g of propylene oxide and 150 g of ethylene oxide. After a one-hour subsequent reaction, the temperature was lowered to 95° C. At this temperature, a mixture of 111.2 g of Dynasylan® GLYEO (from Evonik) and 496 g of propylene oxide was metered in continuously. A one-hour after-reaction was followed by deodorization at p<100 mbar. Then 500 ppm of Irganox® 1135 (from BASF) were stirred in for 15 minutes. This gave a colourless, viscous product (20 600 mPas at 25° C.) having on average 4 mol of triethoxysilyl groups and 2 OH groups per molecule and a polydispersity M_{w}/Mₙ of 2.8.

### Silylpolyether SP 4 (Urethane-Modified, Pendently Alkoxysilyl-Functional Polyetherester; According to DE 102012203737):

640.1 g of silyl polyether SP 3 were introduced as an initial charge and heated to 60° C. Then 22.0 g of IPDI were added, the mixture was stirred for five minutes, and 0.072 g of TIB Kat 216 (dioctyltin dilaurate) were added. The mixture was stirred for 45 minutes and heated to 80° C. and 49.2 g of a polyether of the general formula C₄H₉O[CH₂CH(CH₃)O]_{5.6}H were added. This was followed by stirring for a further 3 hours. The product had a viscosity of 74 100 mPas at 25° C. and a polydispersity M_{w}/Mₙ of 7.9.

### Silyl Polyether SP 5 (Pendently Alkoxysilyl-Functional Polyetherester):

A 5 litre autoclave was charged with 135 g of Baycoll® CD 2084 (polyesterdiol from Bayer Material Science) with an average molar mass of 1350 g/mol, and this initial charged was admixed with 100 ppm (based on the total batch) of a zinc hexacyanocobaltate double metal cyanide catalyst. As described in Example SP 1, the reactor was inertized and volatile components were removed by degassing. The catalyst was activated by the metered addition of 60 g of propylene oxide into the evacuated reactor at 130° C. Following the onset of reaction, 244 g of propylene oxide were metered in continuously over about 50 minutes, followed after a 10-minute after-reaction by the metered addition of a mixture of 385 g of propylene oxide and 223 g ethylene oxide. After subsequent reaction for an hour, the temperature was lowered to 110° C. At this temperature a mixture of 83.4 g of Dynasylan® GLYEO (from Evonik) and 512.5 g of propylene oxide was metered in continuously. Following continued reaction for an hour, deodorization was carried out at p<100 mbar. Then 500 ppm of Irganox® 1135 (from BASF) were stirred in for 15 minutes. This gave a colourless, viscous product (14 700 mPas at 25° C.) having on average 3 mol of triethoxysilyl groups and 2 OH groups per molecule and a polydispersity M_{w}/Mₙ of 2.2.

### Silyl Polyether SP 6 (Urethane-Modified, Pendently Alkoxysilyl-Functional Polyetherester; Process According to DE 102012203737):

582.0 g of silyl polyether SP 5 were introduced as an initial charge and heated to 60° C. Then 15.76 g of IPDI were added, the mixture was stirred for five minutes, and 0.068 g of TIB Kat 216 (dioctyltin dilaurate) were added. The mixture was stirred for 45 minutes and heated to 80° C. and 48.7 g of a polyether of the general formula C₄H₉O[CH₂CH(CH₃)O]_{5.6}H were added. This was followed by stirring for a further 3 hours. The product had a viscosity of 52 800 mPas at 25° C. and a polydispersity M_{w}/Mₙ of 6.5.

### Silyl Polyether SP 7 (Pendently Alkoxysilyl-Functional Polyethercarbonate):

A 5 litre autoclave was charged with 150 g of Desmophen® C 1100 (polycarbonatediol from Bayer MaterialScience) with an average molar mass of 1000 g/mol and this initial charge was admixed with 100 ppm (based on the total batch) of a zinc hexacyanocobaltate double metal cyanide catalyst. As described in Example SP 1, the reactor was inertized and volatile components were removed by degassing. The catalyst was activated by the metering of 60 g of propylene oxide into the evacuated reactor at 130° C. Following the onset of the reaction, a mixture of 885 g of propylene oxide and 370 g of ethylene oxide was metered in continuously over the course of about 160 minutes. After subsequent reaction for an hour, the temperature was lowered to 110° C. At this temperature a mixture of 146 g of Dynasylan® GLYEO (from Evonik) and 850 g of propylene oxide was metered in continuously. A one-hour after-reaction was followed by deodorization at p<100 mbar. Then 500 ppm of Irganox® 1135 (from BASF) were stirred in for 15 minutes. This gave a colourless, viscous product (23 000 mPas at 25° C.) having on average 3.5 mol of triethoxysilyl groups and 2 OH groups per molecule and a polydispersity M_{w}/Mₙ of 3.5.

### Silyl Polyether SP 8 (Urethane-Modified, Pendently Alkoxysilyl-Functional Polyethercarbonate: According to DE 102012203737):

580.0 g of silyl polyether SP 7 were introduced as an initial charge and heated to 60° C. Then 15.72 g of IPDI were added, the mixture was stirred for five minutes, and 0.068 g of TIB Kat 216 (dioctyltin dilaurate) were added. The mixture was stirred for 45 minutes and heated to 80° C. and 46.6 g of a polyether of the general formula C₄H₉O[CH₂CH(CH₃)O]_{5.6}H were added. This was followed by stirring for a further 3 hours. The product had a viscosity of 56 500 mPas at 25° C. and a polydispersity M_{w}/Mₙ of 7.7.

### Silyl Polyether SP 9 (Pendently Alkoxysilyl-Functional Polyetherester):

A 3 litre autoclave was charged under nitrogen with 214.0 g of polypropylene glycol monoallyl ether (average molar mass 430 g/mol), 278.2 g of 3-glycidyloxypropyltriethoxysilane (DYNASYLAN® GLYEO) and 0.225 g of zinc hexacyanocobaltate DMC catalyst. The batch was heated to 150° C., then freed from any volatile ingredients at 30 mbar. After a holding time of 30 min at 150° C. and following activation of the DMC catalyst, the reaction mixture was cooled to 130° C. Subsequently 348.0 g of propylene oxide were supplied over 15 minutes at a maximum internal pressure of 1 bar absolute. At 130° C. and a maximum internal pressure of 1 bar in each case, in succession, 114.0 g of ε-caprolactone over 25 minutes, 216.1 g of 1,2-butylene oxide over 15 minutes, 236.2 g of 3-glycidyloxypropyltrimethoxysilane (DYNASYLAN® GLYMO) over 45 minutes, 120.0 g of styrene oxide over 15 minutes and, finally, 290 g of propylene oxide over 40 minutes were added. Following each added portion, a holding time was observed for approximately 15 minutes at 130° C. before the next monomer was metered in. The metering of the propylene oxide end block was followed by a subsequent reaction time of 30 minutes at 130° C. To conclude, degassing was carried out in order to remove volatile fractions. The slightly yellowish aromatically modified polyetherester obtained contains on average per molecule, in blockwise succession, 2 mol of DYNASYLAN® GLYEO, 12 mol of propylene oxide, 2 mol of ε-caprolactone, 6 mol of 1,2-butylene oxide, 2 mol of DYNASYLAN® GLYMO, 2 mol of styrene oxide and 10 mol of propylene oxide as end block. The OH number is 18.0 mg KOH/g, the average molar mass 3120 g/mol. Free epoxide groups are not detectable in the end product.

### Silyl Polyether SP 10 (Pendently Alkoxysilyl-Functional Polyetherester):

A 3 litre autoclave was charged under nitrogen with 375.0 g of polypropylene glycol monobutyl ether (average molar mass 750 g/mol), 154.0 g of hexahydrophthalic anhydride (HHPSA) and 0.350 g of zinc hexacyanocobaltate DMC catalyst. The batch was heated to 130° C. and then freed at 30 mbar from any volatile ingredients. To activate the DMC catalyst, a portion of 58.0 g of propylene oxide was fed in. Following onset of the reaction (drop in internal pressure), 418.0 g of 3-glycidyloxypropyltriethoxysilane (DYNASYLAN® GLYEO) were added over 20 minutes at 130° C. Following a subsequent reaction time of 150 minutes at 130-150° C., the reaction mixture was cooled to 130° C. The addition of 435.0 g of propylene oxide at 130° C. over the course of 15 minutes was followed by the degassing stage, for removal of volatile fractions. The colourless polyetherester obtained contains on average per molecule 2 mol of HHPSA and 3 mol of DYNASYLAN® GLYEO in a statistically mixed sequence, followed by a 30 mol end block of propylene oxide units. The OH number is 23.0 mg KOH/g, the average molar mass 2440 g/mol. Free epoxide groups are not detectable in the end product.

### Silyl Polyether SP 11 (Pendently Alkoxysilyl-Functional Polyethercarbonate):

A 3 litre autoclave was charged under nitrogen with 375.0 g of polypropylene glycol monobutyl ether (average molar mass 750 g/mol) and 0.16 g of zinc hexacyanocobaltate DMC catalyst. The batch was heated to 130° C. and then freed at 30 mbar from any volatile ingredients. The DMC catalyst was activated by supplying a portion of 354.3 g of 3-glycidyloxypropyltrimethoxysilane (DYNASYLAN® GLYMO). After onset of the reaction and after DYNASYLAN® GLYMO had been consumed by reaction, the batch was cooled to 110° C. Gaseous carbon dioxide is metered into the autoclave to an internal pressure of 5 bar absolute. 1740.0 g of propylene oxide were added continuously over 110 minutes at 110° C. with cooling. A pressure drop to below 5 bar signalled the consumption by reaction of carbon dioxide. During the propylene oxide feed, further carbon dioxide was fed in in portions to maintain the internal reactor pressure of between 4 and 5 bar. After 90 minutes of subsequent reaction at 110° C. and after a pressure drop to <2 bar, the batch was degassed under reduced pressure in order to remove volatile fractions.

The low-viscosity polyethercarbonate obtained contains a DYNASYLAN® GLYMO block (3 trialkoxysilyl units on average per molecule) and also a 60 mol propylene oxide block in which carbonate groups are distributed statistically. The product has an OH number of 12 mg KOH/g and an average molar mass of 4675 g/mol. The carbonate content is about 4 wt %. Free epoxide groups are not detectable in the end product.

TABLE 1
Epoxide compounds used:

| | | Epoxide |
|---|---|---|
| | | equivalent |
| Epoxide | | [g/mol] |
| E 1 | Bisphenol A diglycidyl ether (ABCR) | 180 |
| E 2 | Bisphenol F diglycidyl ether (Epilox ® F 17-00, | 165 |
| | Leuna Harze GmbH) | |

TABLE 2
Amine and imine curing agents used:

| | | Amine |
|---|---|---|
| Curing | | equivalent |
| agent | | [g/mol] |
| H 1 | Isophoronediamine (Vestamin ® IPD, Evonik) | 42.6 |
| H 2 | Isophoronediamine-methyl isobutyl ketone- | 83.7 |
| | ketimine | |
| H 3 | Jeffamine ® D-230 (Huntsman) | 57.5 |
| H 4 | Jeffamine D-230-methyl isobutyl ketone-ketimine | 98.6 |
| H 5 | m-Xylylenediamine (Aldrich) | 34.1 |
| H 6 | Jeffamine ® D-400 (Huntsman) | 100.0 |
| H 7 | Jeffamine D-400-methyl isobutyl ketone-ketimine | 141.0 |
| H 8 | m-Xylylenediamine-methyl isobutyl ketone- | 75.1 |
| | ketimine | |

### Example 2: Compositions

### Example 2.1: Production of Unfilled 1-Component Compositions

In all of the compositions of Table 3, 0.5 g of TIB-Kat 223 and 3.0 g of Dynasylan® AMEO were used per 100 g of silyl polyether. The components were mixed thoroughly in a Speedmixer® FVS 600 (from Hausschild). Immediately after mixing, the test specimens for the lap bonds (Example 3, Table 5) and the elongation at break (Table 7) were produced. The type and amounts used of epoxide and curing agent (based in each case on 100 g of silyl polyether) are listed in Table 3:

TABLE 3
Master table for unfilled 1-component compositions

| Example | Silyl polyether | Epoxide | | Curing agent | |
|---|---|---|---|---|---|
| Ref 1 | SP 2 | — | — | — | — |
| Ref 2 | SP 1 | — | — | — | — |
| 1 | SP 2 | E 1 | 20 g | H 1 | 4.7 g |
| 2 | SP 1 | E 1 | 20 g | H 3 | 5.7 g |
| 3 | SP 1 | E 1 | 20 g | H 4 | 10.0 g |
| 4 | SP 1 | E 1 | 20 g | H 1 | 4.7 g |
| 5 | SP 1 | E 1 | 20 g | H 2 | 9.5 g |
| 6 | SP 1 | E 1 | 30 g | H 3 | 8.8 g |
| 7 | SP 1 | E 1 | 30 g | H 4 | 15.0 g |
| 8 | SP 1 | E 1 | 30 g | H 1 | 6.5 g |
| 9 | SP 1 | E 1 | 30 g | H 2 | 13.0 g |
| 10 | SP 2 | E 1 | 20 g | H 3 | 5.7 g |
| 11 | SP 2 | E 1 | 20 g | H 4 | 10.0 g |
| 12 | SP 2 | E 1 | 20 g | H 1 | 4.7 g |
| 13 | SP 2 | E 1 | 20 g | H 2 | 9.5 g |
| 14 | SP 2 | E 1 | 30 g | H 3 | 8.8 g |
| 15 | SP 2 | E 1 | 30 g | H 4 | 15.0 g |
| 16 | SP 2 | E 1 | 30 g | H 1 | 6.5 g |
| 17 | SP 2 | E 1 | 30 g | H 2 | 13.0 g |
| 18 | SP 2 | E 2 | 20 g | H 1 | 5.1 g |
| 19 | SP 2 | E 2 | 20 g | H 2 | 10.4 g |
| 20 | SP 3 | E 1 | 20 g | H 2 | 9.5 g |
| 21 | SP 4 | E 1 | 20 g | H 2 | 9.5 g |
| 22 | SP 4 | E 1 | 30 g | H 1 | 7.1 g |
| 23 | SP 5 | E 1 | 20 g | H 5 | 3.2 g |
| 24 | SP 5 | E 1 | 20 g | H 4 | 10.0 g |
| 25 | SP 6 | E 2 | 20 g | H 4 | 10.9 g |
| 26 | SP 6 | E 2 | 20 g | H 3 | 7.1 g |
| 27 | SP 7 | E 1 | 10 g | H 1 | 2.4 g |
| 28 | SP 8 | E 1 | 30 g | H 2 | 14.2 g |
| 29 | SP 8 | E 1 | 20 g | H 4 | 11.2 g |
| 30 | SP 2 | E 1 | 10 g | H 1 | 2.4 g |
| 31 | SP 2 | E 1 | 20 g | H 5 | 3.2 g |
| 32 | SP 2 | E 1 | 20 g | H 6 | 9.0 g |
| 33 | SP 2 | E 2 | 20 g | H 1 | 5.1 g |
| 34 | SP 2 | E 2 | 20 g | H 4 | 10.9 g |
| 35 | SP 5 | E 1 | 20 g | H 4 | 11.2 g |
| 36 | SP 6 | E 2 | 20 g | H 4 | 12.2 g |
| 37 | SP 2 | E 1 | 20 g | H 8 | 7.1 g |
| 38 | SP 2 | E 1 | 20 g | H 7 | 13.0 g |
| 39 | SP 2 | E 1 | 20 g | H 4 | 11.2 g |
| 40 | SP 2 | E 2 | 20 g | H 5 | 3.2 g |

### Example 2.2 Production of Unfilled Two-Component Compositions

The silyl polyether and the epoxy resin as component A and, separately, the amine/imine curing agent with the catalyst TIB-Kat 223 and also Dynasylan® AMEO as component B were mixed beforehand in each case in a Speedmixer® FVS 600 (from Hausschild). Components A and B were homogeneous liquid mixtures. Weighed amounts of the two components were homogenized in the Speedmixer® FVS 600 immediately prior to application.

TABLE 4
Two-component compositions

| Component A | Component B1 | Component B2 |
|---|---|---|
| 100 g silyl | 47 g curing agent H1 | 95 g curing agent H 2 |
| polyether SP 2 | | |
| 20 g epoxide E1 | 30 g Dynasylan ® | 30 g Dynasylan ® |
| | AMEO | AMEO |
| | 5 g TIB Kat 223 | 5 g TIB Kat 223 |

### Example 2.3: Production of Filled 1-Component Compositions

25.9 wt % of the mixtures from Example 2.1, consisting of the silyl polyether, the epoxide compound and the amine or imine curing agent as per Table 3, were mixed thoroughly with 18.1 wt % of diisoundecyl phthalate, 51.1 wt % of a precipitated chalk (Socal® U1S2, Solvay), 0.5 wt % of titanium dioxide (Kronos® 2360, Kronos), 1.4 wt % of adhesion promoter (Dynasylan® AMMO, Evonik), 1.1 wt % of dryer (Dynasylan® VTMO, Evonik), 1.5 wt % of an antioxidant/stabilizer mixture (ratio Irganox® 1135:Tinuvin® 1130:Tinuvin® 292=1:2:2 ratio), and 0.4 wt % of the curing catalyst (TIB® KAT 223, TIB) in a mixer (Speedmixer® FVS 600, Hausschild). The concluded formulation was transferred to PE cartridges and applied immediately thereafter at room temperature.

### Example 3: Performance Investigations

### Example 3.1 Determination of the Tensile Shear Strength of Lap Bonds of Unfilled 1-Component Compositions in Accordance with DIN EN 1465

Lap bonds (adhesive bonds with overlap) were produced with the curable compositions of Example 2.1. For these bonds, two identical substrates (ABS, PMMA or bright aluminium) were bonded to one another in each case. The area of the lap bond was 12.5 cm². The bonds were cured at 23° C. and 50% relative humidity. After 21 days, the bonds were clamped into a universal testing machine (from Shimadzu) and a force was exerted on the bond at constant velocity (10 mm/min) until the bond broke. The breaking force was ascertained.

TABLE 5
Tensile shear strengths of one-component systems (DIN EN 1465)

| | Silyl | | | | | Tensile shear strength [N/mm²] | | |
|---|---|---|---|---|---|---|---|---|
| Example | polyether | Epoxide | | Curing agent | | ABS | PMMA | Aluminium |
| Ref 1 | SP 2 | — | — | — | — | 0.1 | 0.5 | 0.5 |
| 30 | SP 2 | E 1 | 10 g | H 1 | 2.4 g | 0.4 | 0.9 | 0.9 |
| 1 | SP 2 | E 1 | 20 g | H 1 | 4.7 g | 0.9 | 1.09 | 0.8 |
| 31 | SP 2 | E 1 | 20 g | H 5 | 1.6 g | 0.7 | 1.1 | — |
| 32 | SP 2 | E 1 | 20 g | H 6 | 9.0 g | 0.5 | 1.1 | — |
| 13 | SP 2 | E 1 | 20 g | H 2 | 9.5 g | 1.0 | 1.0 | 1.3 |
| 4 | SP 1 | E 1 | 20 g | H 1 | 4.7 g | 0.8 | 1.0 | — |
| 33 | SP 2 | E 2 | 20 g | H 1 | 2.6 g | 1.01 | 1.0 | 0.9 |
| 19 | SP 2 | E 2 | 20 g | H 2 | 10.4 g | 10.0 | 1.1 | 1.1 |
| 20 | SP 3 | E 1 | 20 g | H 2 | 9.5 g | 0.8 | 0.9 | 0.9 |
| 21 | SP 4 | E 1 | 20 g | H 2 | 9.5 g | 010 | 1.1 | 1.2 |
| 22 | SP 4 | E 1 | 30 g | H 1 | 7.1 g | 10, | 1.2 | 1.3 |
| 23 | SP 5 | E 1 | 20 g | H 5 | 3.2 g | 0.8 | 0.9 | — |
| 35 | SP 5 | E 1 | 20 g | H 4 | 11.2 g | 0.7 | 10.0 | 1.0 |
| 36 | SP 6 | E 2 | 20 g | H 4 | 12.2 g | 1.02 | 1.1 | 1.2 |
| 26 | SP 6 | E 2 | 20 g | H 3 | 7.1 g | 1.0 | 1.1 | 1.3 |
| 27 | SP 7 | E 1 | 10 g | H 1 | 2.4 g | 0.5 | 0.8 | 0.9 |
| 28 | SP 8 | E 1 | 30 g | H 2 | 14.2 g | 1.0 | 1.2 | 1.3 |
| 29 | SP 8 | E 1 | 20 g | H 4 | 11.2 g | 1.01 | 1.1 | 1.3 |

### Example 3.2 Determination of the Tensile Shear Strength of Lap Bonds of Unfilled 2-Component Compositions in Accordance with DIN EN 1465

Test specimens of ABS and PMMA were bonded after mixing of the components as set out in Table 4 of Example 2.2, bonding taking place as described above, and the bonds were tested for tensile shear strength in a universal testing machine (from Shimadzu) after 21 days of curing at 23° C. and 50% relative humidity.

TABLE 6
Tensile shear strengths of two-component systems (DIN EN 1465)

| | | | | Tensile | |
|---|---|---|---|---|---|
| | | | | shear strengths | |
| | | | | [N/mm²] | |
| Example | Comp. A | Comp. B1 | Comp. B2 | ABS | PMMA |
| 1 | 120 g | 8.1 g | — | 0.9 | 1.0 |
| 2 | 120 g | — | 13.0 g | 1.0 | 1.0 |

### Example 3.3: Determination of Breaking Force and Elongation at Break of Unfilled 1-Component Compositions in Accordance with DIN 53504

The compositions of Example 2.1 were knife-coated in a layer thickness of 2 mm on a polyethylene surface. The films were stored and cured for up to 28 days at 23° C. and 50% relative humidity. S4 dumbbell specimens were subsequently punched from the films, using a cutter and a toggle press. The dumbbell specimens were clamped for testing into a universal testing machine (from Shimadzu), and determinations were made of the breaking force and of the elongation at break when the specimens were extended at constant velocity (200 mm/min):

TABLE 7
Breaking force and elongation at break of unfilled, cured
1-component compositions (DIN 53504):

| | | Elongation at | | Tensile stress at | |
|---|---|---|---|---|---|
| | | break [%] | | break [N/mm²] | |
| Example | Silyl polyether | 7 d | 28 d | 7 d | 28 d |
| Ref 1 | SP 2 | 30 | 31 | 0.08 | 0.18 |
| 1 | SP 2 | 36 | 35 | 0.43 | 0.47 |
| 2 | SP 1 | 34 | 33 | 0.18 | 0.25 |
| 3 | SP 1 | 40 | 27 | 0.24 | 0.29 |
| 4 | SP 1 | 34 | 40 | 0.18 | 0.29 |
| 5 | SP 1 | 27 | 18 | 0.15 | 0.17 |
| 6 | SP 1 | 36 | 33 | 0.24 | 0.25 |
| 7 | SP 1 | 47 | 35 | 0.30 | 0.31 |
| 8 | SP 1 | 39 | 31 | 0.20 | 0.32 |
| 9 | SP 1 | 29 | 23 | 0.32 | 0.33 |
| 10 | SP 2 | 45 | 41 | 0.27 | 0.33 |
| 11 | SP 2 | 44 | 37 | 0.21 | 0.24 |
| 12 | SP 2 | 36 | 35 | 0.43 | 0.47 |
| 13 | SP 2 | 43 | 35 | 0.30 | 0.47 |
| 14 | SP 2 | 49 | 43 | 0.34 | 0.37 |
| 15 | SP 2 | 61 | 45 | 0.32 | 0.45 |
| 16 | SP 2 | 47 | 46 | 0.68 | 0.68 |
| 17 | SP 2 | 42 | 36 | 0.41 | 0.45 |
| 18 | SP 2 | 38 | 34 | 0.42 | 0.46 |
| 19 | SP 2 | 40 | 37 | 0.34 | 0.43 |
| 20 | SP 3 | 38 | 35 | 0.25 | 0.29 |
| 21 | SP 4 | 40 | 37 | 0.39 | 0.46 |
| 22 | SP 4 | 45 | 43 | 0.62 | 0.68 |
| 23 | SP 5 | 37 | 32 | 0.26 | 0.30 |
| 24 | SP 5 | 40 | 36 | 0.22 | 0.28 |
| 25 | SP 6 | 41 | 40 | 0.35 | 0.42 |
| 26 | SP 6 | 30 | 35 | 0.39 | 0.45 |
| 27 | SP 7 | 44 | 42 | 0.26 | 0.30 |
| 28 | SP 8 | 38 | 38 | 0.55 | 0.61 |
| 29 | SP 8 | 36 | 38 | 0.43 | 0.52 |

The inventive combination of pendently alkoxysilyl-bearing polyethers with epoxides and amine and/or ketimine curing agents produces a significant increase in the tensile strength.

### Example 3.4: Determination of Breaking Force and Elongation at Break in Accordance with DIN 53504 for Filled 1-Component Compositions

The formulations produced in Example 2.3 were knife-coated in a layer thickness of 2 mm on a PE surface. The films were stored for 7 days or 28 days at 23° C. and 50% relative humidity. S2 dumbbell specimens were then punched from the films with the aid of a cutter and a toggle press. The dumbbell specimens were clamped for testing into a universal testing machine (from Shimadzu), and determinations were made of the breaking force and of the elongation at break when the specimens were extended at constant velocity (200 mm/min).

TABLE 8
Breaking force, elongation at break and Shore A hardness of filled,
cured 1-component compositions

| | Elongation at | | Tensile stress at | | Shore A | |
|---|---|---|---|---|---|---|
| | break [%] | | break [N/mm²] | | after 15 s | |
| Example | 7 d | 28 d | 7 d | 28 d | 7 d | 28 d |
| Ref 1 | 214 | 208 | 1.7 | 1.8 | 31 | 34 |
| Ref 2 | 211 | 214 | 1.2 | 1.2 | 26 | 32 |
| 1 | 76 | 67 | 2.1 | 2.3 | 61 | 64 |
| 13 | 79 | 67 | 2.2 | 2.3 | 65 | 68 |
| 10 | 99 | 92 | 2.0 | 2.3 | 57 | 61 |
| 11 | 88 | 75 | 1.9 | 1.9 | 58 | 62 |
| 19 | 78 | 70 | 2.2 | 2.2 | 65 | 67 |
| 34 | 89 | 79 | 2.0 | 2.1 | 60 | 63 |
| 20 | 69 | 71 | 1.9 | 2.0 | 61 | 63 |
| 21 | 81 | 77 | 2.3 | 2.4 | 67 | 70 |
| 22 | 71 | 67 | 2.4 | 2.5 | 70 | 75 |
| 23 | 70 | 68 | 1.9 | 2.1 | 63 | 66 |
| 24 | 75 | 72 | 1.7 | 2.0 | 60 | 63 |
| 25 | 92 | 87 | 2.2 | 2.4 | 66 | 67 |
| 26 | 98 | 90 | 2.1 | 2.3 | 69 | 73 |
| 27 | 125 | 119 | 1.4 | 1.5 | 42 | 44 |
| 28 | 70 | 65 | 2.3 | 2.5 | 70 | 73 |
| 29 | 99 | 95 | 2.3 | 2.3 | 69 | 71 |
| 17 | 84 | 77 | 1.8 | 2.1 | 58 | 64 |
| 37 | 96 | 75 | 1.8 | 2.1 | 53 | 57 |
| 38 | 60 | 56 | 2.0 | 2.3 | 66 | 72 |

The inventive combination of pendently alkoxysilyl-bearing polyethers with epoxides and amine and/or ketimine curing agents produces a significant increase in the tensile strength and Shore A hardness on decreasing extensibility. The inventive curable compositions are therefore particularly suitable for those areas of application that require high-strength adhesive bonds which cannot be achieved just with silyl polymers.

### Example 3.5: Determination of the Tensile Shear Strength of Lap Bonds of Filled 1-Component Compositions in Accordance with DIN EN 1465

Lap bonds were produced with the adhesive/sealant formulations as per Example 2.3. In this case, two identical substrates (ABS, PMMA and steel of class V2A) were used in each case. The area of the lap bond was 12.5 cm². The bonds were cured at 23° C. and 50% relative humidity. After 21 days, the bonds were clamped into a universal testing machine (from Shimadzu) and a force was exerted on the bond at constant velocity (10 mm/min) until the bond broke. The breaking force was ascertained.

TABLE 9

| | Silyl | | | | | Tensile shear | | |
|---|---|---|---|---|---|---|---|---|
| | poly- | | | | | strength [N/mm²] | | |
| Example | ether | Epoxide | | Curing agent | | ABS | PMMA | V2A |
| Ref 1 | SP 2 | — | — | — | — | 0.22 | 1.14 | 1.24 |
| Ref 2 | SP 1 | — | — | — | — | n.d. | n.d. | 0.90 |
| 1 | SP 2 | E 1 | 20 g | H 1 | 4.7 g | 0.84 | 1.21 | 2.20 |
| 13 | SP 2 | E 1 | 20 g | H 2 | 9.5 g | 1.30 | 1.40 | 1.46 |
| 10 | SP 2 | E 1 | 20 g | H 3 | 5.7 g | 1.30 | 1.50 | 1.29 |
| 39 | SP 2 | E 1 | 20 g | H 4 | 11.2 g | 1.10 | 1.20 | 1.60 |
| 32 | SP 2 | E 1 | 20 g | H 6 | 9.0 g | 0.75 | 1.10 | 1.24 |
| 38 | SP 2 | E 1 | 20 g | H 7 | 13.0 g | 1.20 | 1.37 | 1.23 |
| 40 | SP 2 | E 2 | 20 g | H 5 | 3.2 g | 1.48 | 1.42 | 1.54 |
| 37 | SP 2 | E 1 | 20 g | H 8 | 7.1 g | 1.31 | 1.23 | 1.32 |

1. A curable mixture, comprising:
at least one binder composition (A) comprising
compound (a1): at least one silyl polyether pendently bearing from 2 to 10 alkoxysilyl groups, and
compound (a2): at least one epoxide compound; and
at least one curing agent mixture (B) comprising
compound (b1): at least one curing catalyst for crosslinking the polymer pendently bearing alkoxysilyl groups, and
compound (b2): at least one curing agent for the epoxide compound, and
optionally one or more alkoxysilane compounds.

2. The curable mixture according to claim 1, wherein the silyl polyether pendently bearing alkoxysilyl groups is a compound of the formula (1) 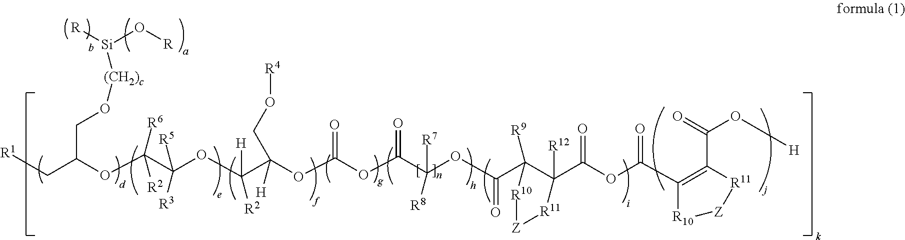
where
a is an integer from 1 to 3,
b is an integer from 0 to 2,
c is an integer from 0 to 22,
d is an integer from greater than 1 up to 500,
e is an integer from 0 to 10 000,
f is an integer from 0 to 1000,
g is an integer from 0 to 1000,
h, i and j independently of one another are integers from 0 to 500,
n is an integer between 2 and 8,
k is an integer from 1 to 6,
R represents one or more identical or different radicals selected from linear or branched, saturated, mono- or polyunsaturated alkyl radicals having 1 to 20, carbon atoms or haloalkyl groups having 1 to 20 carbon atoms,
R¹ is a hydroxyl group or a k-functional radical having 1 to 1500 carbon atoms, it also being possible for the chain to be interrupted by heteroatoms O, S, Si and/or N, or is a radical comprising oxyaromatic system, or is an optionally branched, silicone-containing organic radical which has an oxygen for bonding to the fragment with the index k,
R² or R³, and also R⁵ or R⁶, identically or else independently of one another, are H or a saturated or optionally mono- or polyunsaturated, also further-substituted, optionally mono- or polyvalent hydrocarbon radical,
R⁴ corresponds to a linear or branched alkyl radical of 1 to 24 carbon atoms or to an aromatic or cycloaliphatic radical which may optionally in turn carry alkyl groups,
R⁷ and R⁸ are, independently of one another, either hydrogen or alkyl, alkoxy, aryl or aralkyl groups,
R⁹, R¹⁰, R¹¹ and R¹² are, independently of one another, either hydrogen or alkyl, alkenyl, alkoxy, aryl or aralkyl groups, wherein the hydrocarbon radical may be bridged cycloaliphatically or aromatically by the fragment Z, in which case Z represents a divalent alkylene radical or alkenylene radical,
with the proviso that the fragments with the indices d, e, f and/or h are freely permutable with one another.

3. The curable mixture according to claim 2, wherein in the compound of formula (1) a sum of the indices d, e, f, g, h, and i to j is 10 to 10 000.

4. The curable mixture according to claim 1, wherein the compound (a1) is a urethanized pendently alkoxysilyl-modified silyl polyether.

5. The curable mixture according to claim 4, wherein the urethanized pendently alkoxysilyl-modified silyl polyether is prepared as a reaction product of a reaction of
x1) at least one silyl polyether of the formula (1),
x2) with at least one compound comprising one or more isocyanate groups,
x3) optionally in the presence of one or more catalysts, and
x4) optionally in the presence of other components reactive towards the reaction product.

6. The curable mixture according to claim 1, wherein the compound (a2) is selected from epichlorohydrin-derived glycidyl ethers, glycidyl esters and glycidylamines, or epoxide compounds of unsaturated hydrocarbons and unsaturated fats and/or fatty acids, or oligomeric and polymeric epoxide compounds selected from epoxide-group-bearing polyolefins and siloxanes or epoxide compounds formed by chain extension from diglycidyl ethers with OH-functional compounds.

7. The curable mixture according to claim 1, wherein the compound (a1) and the compound (a2) are present in the mixture in a mass ratio of 100/1 to 1/100.

8. The curable mixture according to claim 1, wherein the catalyst used as compound (b1) is selected from hydrolysis/condensation catalysts for alkoxysilanes, organic tin compounds, tetraalkylammonium compounds, guanidine compounds, guanidine-siloxane compounds and bismuth catalysts.

9. The curable mixture according to claim 1, wherein the compound (b2) is an amine or an imine.

10. The curable mixture according to claim 9, wherein the imines as compound (b2) have at least one structural element of the formula (2), 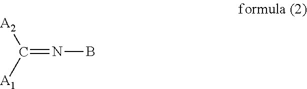
where
A₁ and A₂ independently of one another are hydrogen or an organic radical, the radicals A₁ and A₂ originating from a condensation reaction of an amine-functional compound B—NH₂ with a carbonyl compound A₁-C(═O)-A₂ and therefore correspond to the radicals of the carbonyl compound used, it being the case that, if the radicals originate from a compound which has a keto function, both radicals A₁ and A₂ are each an organic radical and, if the radicals originate from a compound which has an aldehyde function, at least one of the two radicals A₁ and A₂ is an organic radical and the other of the radicals is hydrogen in each case, and B is any organic radical or an organomodified siloxane or silane radical, wherein A₁ and A₂ may be part of a ring and may be linked to one another by an organic radical.

11. The curable mixture according to claim 1, wherein a molar ratio of epoxide groups of the compound (a2) to reactive N—H groups of the compound (b2) is between 2:1 to 1:3.

12. The curable mixture according to claim 1, further comprising one or more additives selected from the group consisting of the plasticizers, fillers, solvents, adhesion promoters, rheological additives, stabilizers, catalysts, solvents and dryers.

13. The curable mixture according to claim 1, wherein the mixture, based on the binder mixture (A), has 10 to 90 wt % of the compound (a1), the compound (a1) having on average between greater than 1 and up to 4 trialkoxysilyl functions per silyl polyether of the formula (1).

14. The curable mixture according to claim 1, wherein the compound (a1) comprises urethanized silyl polyethers having on average between 1 and up to 4 triethoxysilyl functions per silyl polyether of the formula (1).

15. A sealant or adhesive, comprising the curable mixture according to claim 1.
